(19) United States
(12) Patent Application Publication
(10) Pub. No.: US 2026/0156545 A1
(43) Pub. Date: Jun. 4, 2026

(54) MOBILITY CONDITION EVALUATION IN WIRELESS COMMUNICATIONS

(71) Applicant: LG ELECTRONICS INC., Seoul (KR)

(72) Inventors: Hongsuk KIM, Seoul (KR); Sunghoon JUNG, Seoul (KR); Sangwon KIM, Seoul (KR); Siyoung CHOI, Seoul (KR)

(21) Appl. No.: 18/715,628

(22) PCT Filed: Feb. 5, 2024
(86) PCT No.: PCT/KR2024/001650

§ 371 Date: May 31, 2024

Related U.S. Application Data
(60) Provisional application No. 63/446,332, filed on Feb. 16, 2023.

(51) Int. Cl. H04W 36/00; H04W 36/36

(52) U.S. Cl. CPC H04W 36/00835; H04W 36/362

(57) ABSTRACT

The present disclosure relates to mobility condition evaluation in wireless communications. According to an embodiment of the present disclosure, a method performed by a user equipment (UE) configured to operate in a wireless communication system comprises: receiving a conditional reconfiguration comprising one or more execution conditions for a target primary cell (PCell); determining whether one or more execution conditions of first type for the target primary secondary cell (PSCell) are configured in the conditional reconfiguration; based on the one or more execution conditions of first type for the target PSCell being configured in the conditional reconfiguration, evaluating the one or more execution conditions for the target PCell together with the one or more execution conditions of first type for the target PSCell; and performing a conditional PSCell mobility to the target PSCell, based on the one or more execution conditions for the target PCell and the one or more execution conditions of first type for the target PSCell being fulfilled.

### CROSS-REFERENCE TO RELATED APPLICATIONS

This application is the National Stage filing under 35 U.S.C. 371 of International Application No. PCT/KR2024/001650, filed on Feb. 5, 2024, which claims the benefit of U.S. Provisional Application No. 63/446,332 filed on Feb. 16, 2023, which is all hereby incorporated by reference herein in its entirety.

### TECHNICAL FIELD

The present disclosure is related to mobility condition evaluation in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In a wireless communication system, a user equipment (UE) may perform a conditional mobility to a target cell. The conditional mobility may comprise may comprise at least one of a conditional PCell change/conditional handover (CHO) or a conditional PSCell mobility. The conditional PSCell mobility may comprise conditional PSCell addition/change (CPAC), including conditional PSCell addition (CPA) and/or conditional PSCell change (CPC). The UE may evaluate CHO/CPA/CPC execution conditions, and perform a mobility to a target cell which satisfies the corresponding execution condition(s).

### SUMMARY

An aspect of the present disclosure is to provide method and apparatus for selection of mobility timer value in a wireless communication system.

According to an embodiment of the present disclosure, a method performed by a user equipment (UE) configured to operate in a wireless communication system comprises: receiving a conditional reconfiguration comprising one or more execution conditions for a target primary cell (PCell); determining whether one or more execution conditions of first type for the target primary secondary cell (PSCell) are configured in the conditional reconfiguration; based on the one or more execution conditions of first type for the target PSCell being configured in the conditional reconfiguration, evaluating the one or more execution conditions for the target PCell together with the one or more execution conditions of first type for the target PSCell; and performing a conditional PSCell mobility to the target PSCell, based on the one or more execution conditions for the target PCell and the one or more execution conditions of first type for the target PSCell being fulfilled.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: receiving a conditional reconfiguration comprising one or more execution conditions for a target primary cell (PCell); determining whether one or more execution conditions of first type for the target primary secondary cell (PSCell) are configured in the conditional reconfiguration; based on the one or more execution conditions of first type for the target PSCell being configured in the conditional reconfiguration, evaluating the one or more execution conditions for the target PCell together with the one or more execution conditions of first type for the target PSCell; and performing a conditional PSCell mobility to the target PSCell, based on the one or more execution conditions for the target PCell and the one or more execution conditions of first type for the target PSCell being fulfilled.

According to an embodiment of the present disclosure, a network node related to a source primary cell (PCell) for conditional handover (CHO) configured to operate in a wireless communication system comprises: at least one transceiver; at least one processor; and at least one memory operatively coupled to the at least one processor and storing instructions that, based on being executed by the at least one processor, perform operations comprising: transmitting, to a user equipment (UE), a radio resource control (RRC) reconfiguration message comprising a conditional reconfiguration comprising one or more execution conditions for a target PCell; and receiving, from the UE, an RRC reconfiguration complete message, wherein the UE is configured to: determine whether one or more execution conditions of first type for the target primary secondary cell (PSCell) are configured in the conditional reconfiguration; based on the one or more execution conditions of first type for the target PSCell being configured in the conditional reconfiguration, evaluate the one or more execution conditions for the target PCell together with the one or more execution conditions of first type for the target PSCell; and perform a conditional PSCell mobility to the target PSCell, based on the one or more execution conditions for the target PCell and the one or more execution conditions of first type for the target PSCell being fulfilled.

According to an embodiment of the present disclosure, a method performed by a network node related to a source primary cell (PCell) for conditional handover (CHO) configured to operate in a wireless communication system comprises: transmitting, to a user equipment (UE), a radio resource control (RRC) reconfiguration message comprising a conditional reconfiguration comprising one or more execution conditions for a target PCell; and receiving, from the UE, an RRC reconfiguration complete message, wherein the UE is configured to: determine whether one or more execution conditions of first type for the target primary secondary cell (PSCell) are configured in the conditional reconfiguration; based on the one or more execution conditions of first type for the target PSCell being configured in the conditional reconfiguration, evaluate the one or more execution conditions for the target PCell together with the one or more execution conditions of first type for the target PSCell; and perform a conditional PSCell mobility to the target PSCell, based on the one or more execution conditions for the target PCell and the one or more execution conditions of first type for the target PSCell being fulfilled.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: receiving a conditional reconfiguration comprising one or more execution conditions for a target primary cell (PCell); determining whether one or more execution conditions of first type for the target primary secondary cell (PSCell) are configured in the conditional reconfiguration; based on the one or more execution conditions of first type for the target PSCell being configured in the conditional reconfiguration, evaluating the one or more execution conditions for the target PCell together with the one or more execution conditions of first type for the target PSCell; and performing a conditional PSCell mobility to the target PSCell, based on the one or more execution conditions for the target PCell and the one or more execution conditions of first type for the target PSCell being fulfilled.

According to an embodiment of the present disclosure, a non-transitory computer readable medium (CRM) has stored thereon a program code implementing instructions that, based on being executed by at least one processor, perform operations comprising: receiving a conditional reconfiguration comprising one or more execution conditions for a target primary cell (PCell); determining whether one or more execution conditions of first type for the target primary secondary cell (PSCell) are configured in the conditional reconfiguration; based on the one or more execution conditions of first type for the target PSCell being configured in the conditional reconfiguration, evaluating the one or more execution conditions for the target PCell together with the one or more execution conditions of first type for the target PSCell; and performing a conditional PSCell mobility to the target PSCell, based on the one or more execution conditions for the target PCell and the one or more execution conditions of first type for the target PSCell being fulfilled.

The present disclosure may have various advantageous effects.

For example, the UE can check whether simultaneous evaluation of execution conditions for CHO and the associated CPC is available based on the configured execution condition. The UE can select suitable PSCell from the associated CPC configuration while performing the simultaneous evaluation.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a dual connectivity (DC) architecture to which technical features of the present disclosure can be applied.

FIG. 9 shows an example of a conditional mobility procedure according to an embodiment of the present disclosure.

FIG. 10 shows an example of a method performed by a UE according to an embodiment of the present disclosure.

FIG. 11 shows an example of a signal flow between a UE and a network node according to an embodiment of the present disclosure.

FIG. 12 shows an example of a method for simultaneous evaluation of conditional PCell/PSCell mobility conditions according to an embodiment of the present disclosure.

FIG. 13 shows an example of a first implementation of a method for simultaneous evaluation of conditional PCell/PSCell mobility conditions according to an embodiment of the present disclosure.

FIG. 14 shows an example of a second implementation of a method for simultaneous evaluation of conditional PCell/PSCell mobility conditions according to an embodiment of the present disclosure.

FIG. 15 shows an example of a third implementation of a method for simultaneous evaluation of conditional PCell/PSCell mobility conditions according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

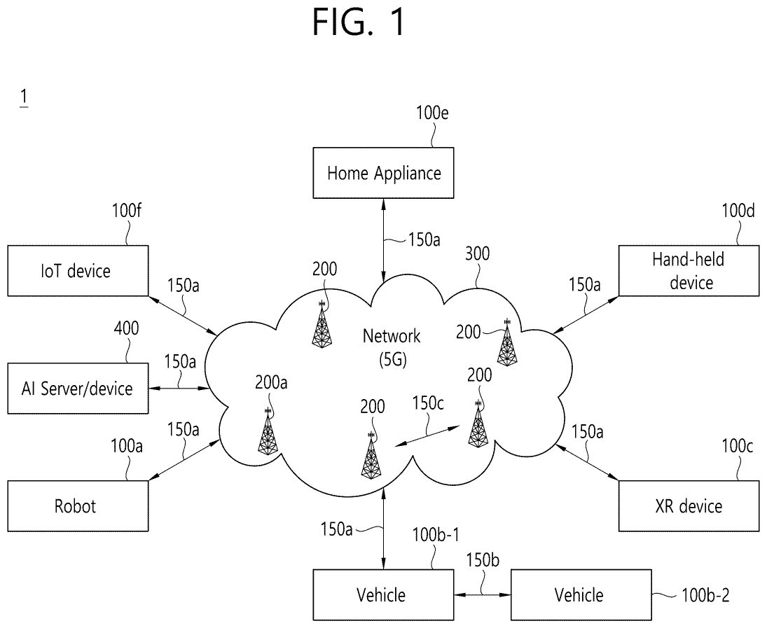

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

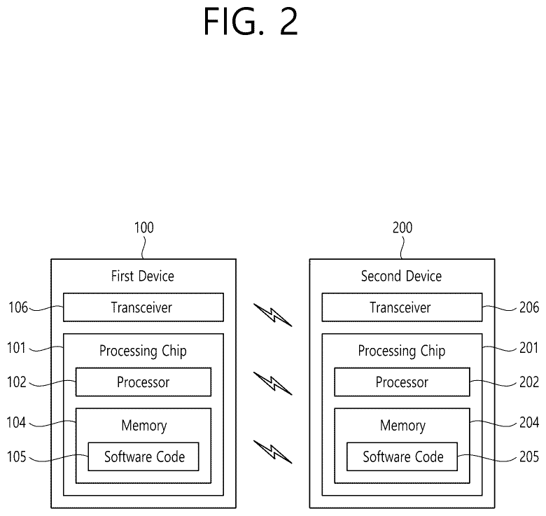

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

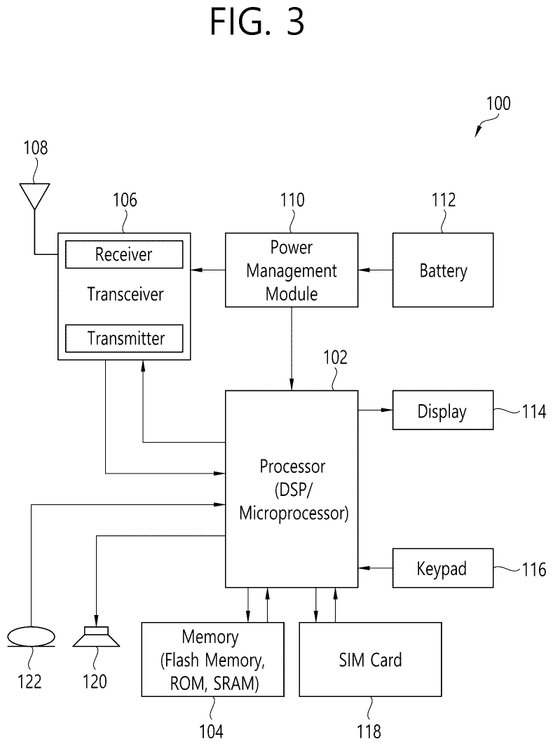

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®. ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 43.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

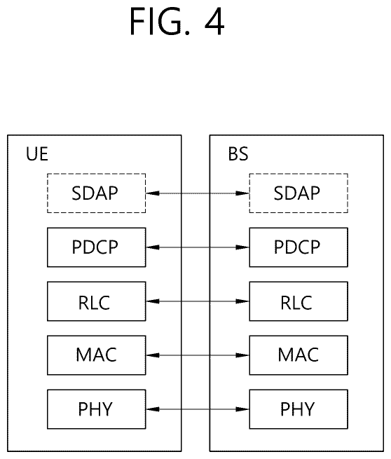

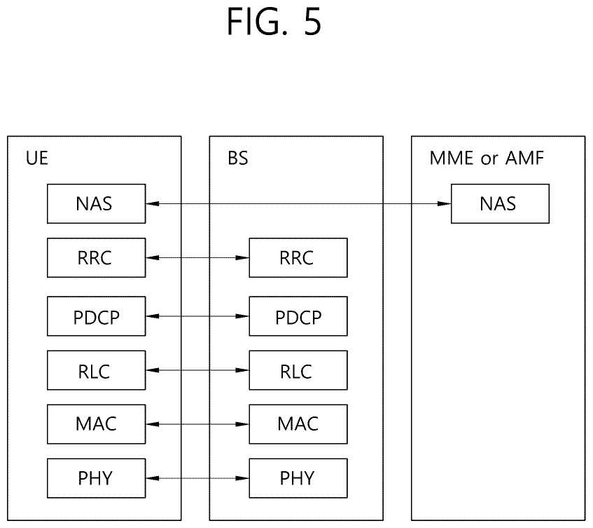

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (L1, for example PHY layer) and Layer 2 (L2, for example MAC/RLC/PDCP layer). Referring to FIG. 5, the control plane protocol stack may be divided into Layer 1 (L1, for example PHY layer), Layer 2 (L2, for example MAC/RLC/PDCP layer), Layer 3 (L3, for example an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

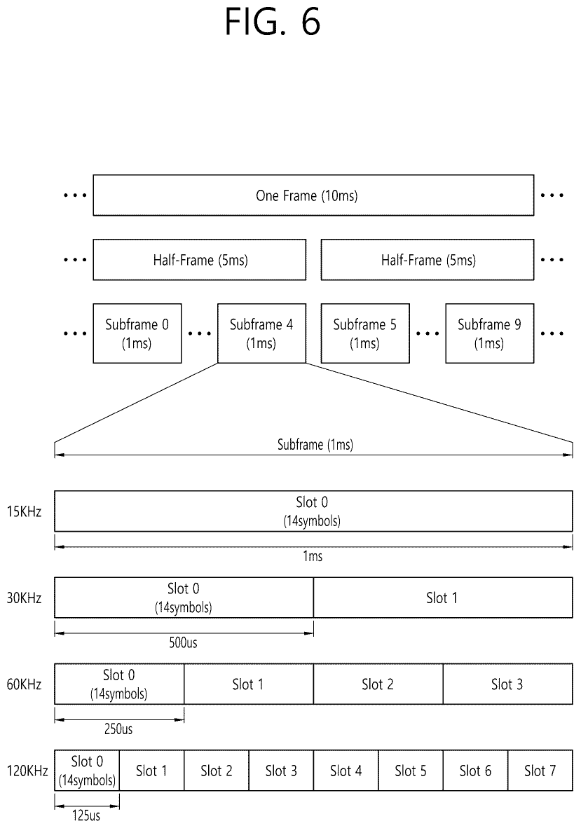

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain. As shown in FIG. 6, as SCS doubles, the slot length and symbol length are halved. For example, when SCS is 15 kHz, the slot length is 1 ms, which is the same as the subframe length. When SCS is 30 kHz, the slot length is 0.5 ms (=500 us), and the symbol length is half of that when the SCS is 15 kHz. When SCS is 60 kHz, the slot length is 0.25 ms (=250 us), and the symbol length is half of that when the SCS is 30 kHz. When SCS is 120 kHz, the slot length is 0.125 ms (=125 us), and the symbol length is half of that when the SCS is 60 kHz. When SCS is 240 kHz, the slot length is 0.0625 ms (=62.5 us), and the symbol length is half of that when the SCS is 120 KHz.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

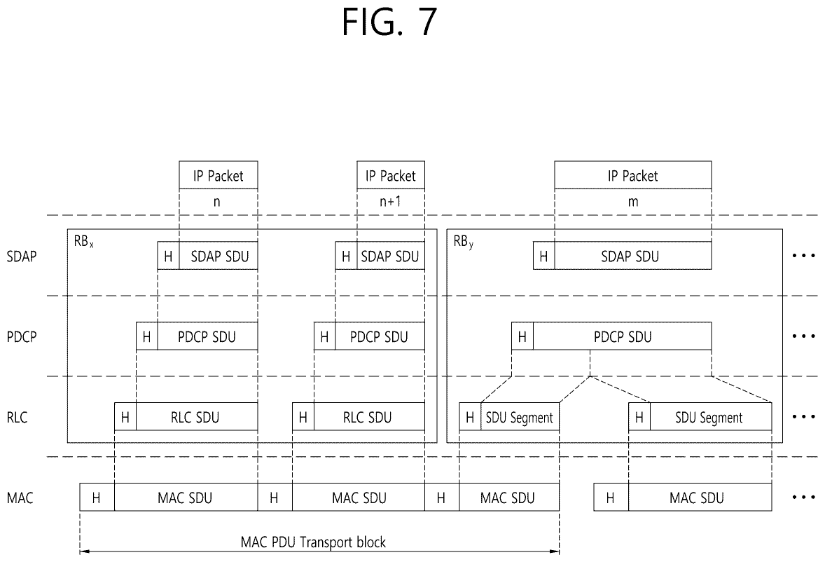

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and random access channel (RACH) are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

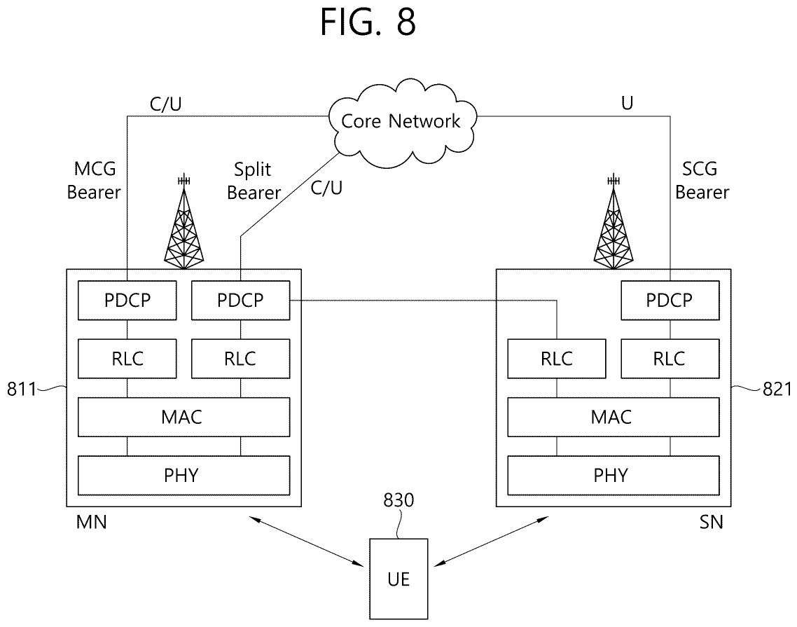

FIG. 8 shows an example of a dual connectivity (DC) architecture to which technical features of the present disclosure can be applied.

Referring to FIG. 8, MN 811, SN 821, and a UE 830 communicating with both the MN 811 and the SN 821 are illustrated. As illustrated in FIG. 8, DC refers to a scheme in which a UE (e.g., UE 830) utilizes radio resources provided by at least two RAN nodes comprising a MN (e.g., MN 811) and one or more SNs (e.g., SN 821). In other words, DC refers to a scheme in which a UE is connected to both the MN and the one or more SNs, and communicates with both the MN and the one or more SNs. Since the MN and the SN may be in different sites, a backhaul between the MN and the SN may be construed as non-ideal backhaul (e.g., relatively large delay between nodes).

MN (e.g., MN 811) refers to a main RAN node providing services to a UE in DC situation. SN (e.g., SN 821) refers to an additional RAN node providing services to the UE with the MN in the DC situation. If one RAN node provides services to a UE, the RAN node may be a MN. SN can exist if MN exists.

For example, the MN may be associated with macro cell whose coverage is relatively larger than that of a small cell. However, the MN does not have to be associated with macro cell—that is, the MN may be associated with a small cell. Throughout the disclosure, a RAN node that is associated with a macro cell may be referred to as ‘macro cell node’. MN may comprise macro cell node.

For example, the SN may be associated with small cell (e.g., micro cell, pico cell, femto cell) whose coverage is relatively smaller than that of a macro cell. However, the SN does not have to be associated with small cell—that is, the SN may be associated with a macro cell. Throughout the disclosure, a RAN node that is associated with a small cell may be referred to as ‘small cell node’. SN may comprise small cell node.

The MN may be associated with a master cell group (MCG). MCG may refer to a group of serving cells associated with the MN, and may comprise a primary cell (PCell) and optionally one or more secondary cells (SCells). User plane data and/or control plane data may be transported from a core network to the MN through a MCG bearer. MCG bearer refers to a bearer whose radio protocols are located in the MN to use MN resources. As shown in FIG. 8, the radio protocols of the MCG bearer may comprise PDCP, RLC, MAC and/or PHY.

The SN may be associated with a secondary cell group (SCG). SCG may refer to a group of serving cells associated with the SN, and may comprise a primary secondary cell (PSCell) and optionally one or more SCells. User plane data may be transported from a core network to the SN through a SCG bearer. SCG bearer refers to a bearer whose radio protocols are located in the SN to use SN resources. As shown in FIG. 8, the radio protocols of the SCG bearer may comprise PDCP, RLC, MAC and PHY.

User plane data and/or control plane data may be transported from a core network to the MN and split up/duplicated in the MN, and at least part of the split/duplicated data may be forwarded to the SN through a split bearer. Split bearer refers to a bearer whose radio protocols are located in both the MN and the SN to use both MN resources and SN resources. As shown in FIG. 8, the radio protocols of the split bearer located in the MN may comprise PDCP, RLC, MAC and PHY. The radio protocols of the split bearer located in the SN may comprise RLC, MAC and PHY.

According to various embodiments, PDCP anchor/PDCP anchor point/PDCP anchor node refers to a RAN node comprising a PDCP entity which splits up and/or duplicates data and forwards at least part of the split/duplicated data over X2/Xn interface to another RAN node. In the example of FIG. 8, PDCP anchor node may be MN.

According to various embodiments, the MN for the UE may be changed. This may be referred to as handover, or a MN handover.

According to various embodiments, a SN may newly start providing radio resources to the UE, establishing a connection with the UE, and/or communicating with the UE (i.e., SN for the UE may be newly added). This may be referred to as a SN addition.

According to various embodiments, a SN for the UE may be changed while the MN for the UE is maintained. This may be referred to as a SN change.

According to various embodiments, DC may comprise E-UTRAN NR-DC (EN-DC), and/or multi-radio access technology (RAT)-DC (MR-DC). EN-DC refers to a DC situation in which a UE utilizes radio resources provided by E-UTRAN node and NR RAN node. MR-DC refers to a DC situation in which a UE utilizes radio resources provided by RAN nodes with different RATs.

Hereinafter, contents regarding mobility are described.

The mobility may comprise PCell change, PSCell change (or, secondary node (SN) change), and/or PSCell addition (or, SN addition).

There may be at least two types of mobility: network-controlled mobility (or, legacy mobility) and UE-based mobility (or, conditional mobility).

The network-controlled mobility (or, legacy mobility) is a mobility where the network determines a target cell for mobility, and configures UE with the target cell. The network may transmit, to the UE, an RRCReconfiguration message comprising a configuration for the target cell. The UE may execute a mobility to the target cell/apply the configuration for the target cell, upon receiving the cell configuration for the target cell.

The UE-based mobility (or, conditional mobility) is a mobility where the network configures the UE with a plurality of candidate cells, and the UE determines a target cell which satisfies a mobility execution condition among the plurality of candidate cells. The conditional mobility may comprise at least one of a conditional PCell change/conditional handover (CHO) or a conditional PSCell mobility. The conditional PSCell mobility may comprise conditional PSCell addition/change (CPAC), including conditional PSCell addition (CPA) and/or conditional PSCell change (CPC). The network may transmit, to the UE, an RRCReconfiguration message comprising ConditionalReconfiguration information element (IE), which comprises a list of conditional reconfigurations for the plurality of candidate cells. A conditional reconfiguration for a candidate cell may comprise an identifier of the conditional reconfiguration, a mobility execution condition for the candidate cell, and a configuration for the candidate cell. The UE may evaluate the mobility execution conditions for the plurality of candidate cells, and when a mobility execution condition for a candidate cell is satisfied, the UE may consider the candidate cell as a target cell, and execute a mobility to the target cell/apply the configuration for the target cell.

In the present disclosure, the term “handover (HO)” may mean PCell change, or may be a broad concept that includes not only PCell change but also PSCell change/addition.

In the present disclosure, the terms “handover”, “mobility” and “cell switch” can be used interchangeably.

In the present disclosure, the description regarding handover can also be applied to other mobility procedures (e.g., PSCell change/addition).

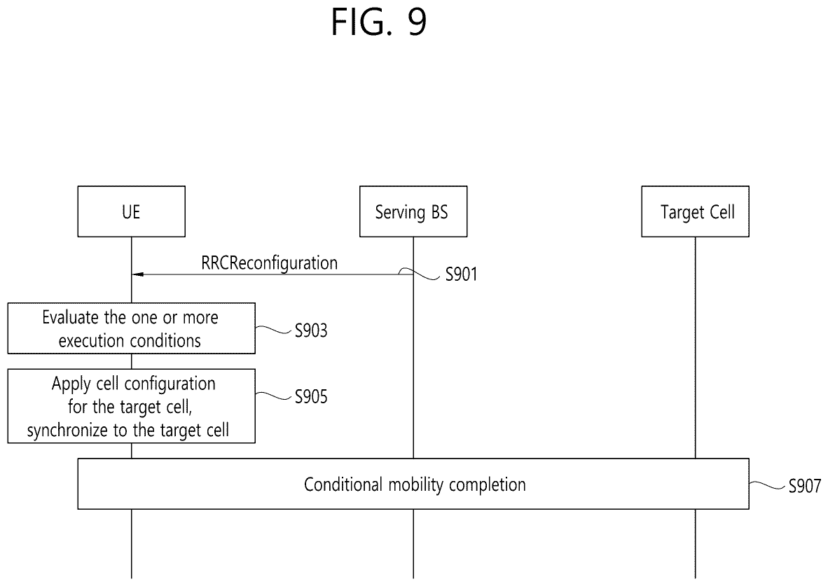

FIG. 9 shows an example of a conditional mobility procedure according to an embodiment of the present disclosure.

In FIG. 9:
the serving BS may be related to a PCell, which may be a source PCell for CHO;
the serving BS may be an MN associated with an SN in DC, where the SN may be related to a source PSCell for CPC; and
the target cell may be a target PCell for CHO, or a target PSCell for CPA/CPC.

Referring to FIG. 9, in step S901, UE may receive, from the serving BS, an RRCReconfiguraiton message comprising a conditional reconfiguration information element (IE) (i.e., CondidtionalReconfiguration). The conditional reconfiguration IE may comprise a list of conditional reconfigurations for candidate cells including the target cell. Each conditional reconfiguration in the list may be related to the corresponding candidate cell, and comprises i) an identifier of the corresponding conditional reconfiguration (i.e., condReconfigId), ii) one or more execution conditions for the corresponding candidate cell (i.e., condExecutionCond), and/or iii) RRC reconfiguration for the corresponding candidate cell (i.e., condRRCReconfig) including a cell configuration for the corresponding candidate cell. The one or more execution conditions may comprise CHO execution condition(s), CPA execution condition(s), and/or CPC execution condition(s).

In step S903, the UE may start evaluating the one or more execution conditions for the candidate cells. In FIG. 9, it is assumed that the target cell satisfies the corresponding execution condition(s).

In step S905, the UE may detach from the source PCell/PSCell (for a case of CHO/CPC), apply the RRC reconfiguration for the target cell including a cell configuration for the target cell, and/or synchronize to the target cell. The UE may skip a random access towards the target cell if timing advance (TA) information for the target cell is available—otherwise, the UE should perform a random access (e.g., contention-free random access (CFRA) and/or contention-based random access (CBRA)) towards the target cell.

In step S907, the UE may complete the conditional mobility procedure by sending RRCReconfiguraitonComplete message to the target cell.

In some implementations, the UE may release conditional reconfiguration(s) after successful completion of the conditional mobility procedure.

Hereinafter, simultaneous evaluation for CHO and CPAC is described.

In a wireless communication system, CHO including target MCG and target SCG may be supported, and CHO configuration referring to or including CPC/CPA configuration (intended to be applicable together) may be supported. When triggering CHO, UE may perform CPC/CPA configuration to start CPC/CPA evaluation. CHO evaluation and CPC/CPA evaluation may be concurrent or sequential.

As stated above, CHO with SCG configurations is already supported. However, the CHO with SCG configuration is still triggered under the normal CHO triggering conditions (e.g., CondEventA3, CondEventA5) that are based only on the target/source PCell's quality. The drawback of this is that the target SCG (PSCell) is added blindly without taking its quality (or/and the source PSCell) into consideration. Doing so may result in adding an SCG in bad radio conditions, and subsequent SCG failure, SCG failure recovery and reconfigurations.

Thus, a more optimal approach is to also consider the conditions of the target/source PSCell. That is:
A UE can be configured with a CHO and associated SCG and configured to consider triggering conditions on the source/target PCell and source/target PSCell; and/or
A UE will monitor both triggering conditions and execute the CHO with the associated SCG only if both triggering conditions are fulfilled.

In some scenarios, it could be possible that there can be several candidate PSCells for a certain PCell. This can be realized via implementation, where a CHO with associated SCG is configured for each possible PSCell. However, this is inefficient signalling, as the MCG configuration is repeated in each configuration. A more optimal solution is to have a CHO that can be configured/associated with multiple SCGs, each with its own triggering conditions. For example, a CHO can be associated with multiple SCGs, each having different triggering conditions.

For example, a UE may be configured with a CHO configuration that has two associated SCGs, SCG1 and SCG2. If the triggering conditions for the PCell and PSCell1 get fulfilled, the UE will execute the CHO with SCG1. If the triggering conditions for the PCell and PSCell2 get fulfilled, the UE will execute the CHO with SCG2. Releasing all conditional reconfigurations upon the execution of another conditional reconfiguration will result in unnecessary reconfigurations. Thus, it is proposed that, when a UE executes a CHO with multiple SCGs associated with it, it may be configured to keep the other SCG configurations associated with the SCG and keep monitoring their triggering conditions.

With regard to the RRC signalling structure design, there are two main possibilities:
a) A CHO containing the MCG configuration (and triggering conditions) and the associated SCG configuration(s) (and the SCG triggering conditions)
b) A CHO containing only the MCG configuration (and PCell change triggering condition), separate configuration for each SCG (i.e., a CPC with SCG configuration and PSCell change triggering condition), and a configuration associating the CHO with the SCG configuration(s) (e.g., in a way like a measurement ID associates a measurement object and a measurement reporting configuration).

That is, at least one of the following structures for defining CHO with associated SCG may be considered:
a) One CHO configuration containing all the MCG configuration, SCG configuration(s), and triggering conditions for the PCell change and PSCell change; and/or
b) Separate CHO and CPAC configuration(s), and a configuration associating the CHO and CPAC configuration(s).

Meanwhile, UE may be configured with CHO and associated CPC which is supposed to be used after CHO execution—that is, the network may configure CHO configuration and CPC configuration which references the CHO configuration or is included in the CHO configuration. Through this feature, the UE can more precisely select a suitable target PSCell than in a case where the UE is configured with the CHO configuration and associated SCG configuration together. This is because the associated SCG configuration which should be applied after CHO is completed may be invalid, since a long time has passed from the CHO evaluation.

For the case that the UE is configured with CHO and the associated CPC together, the UE may evaluate execution conditions for CHO and the associated CPC simultaneously to execute CPC quickly. To perform evaluation of execution condition for CHO and execution condition for the associated CPC together, the UE may require new conditions. For example, the execution condition for a non-serving cell (i.e., PSCell of the associated CPC) before CHO execution may be required.

The problem is that there is no requirement when the UE can start to perform the simultaneous evaluation of execution conditions for the CHO and the associated CPC and when the UE should stop the simultaneous evaluation. If the network doesn't indicate which execution conditions are allowed for the simultaneous evaluation, the UE may evaluate wrong execution condition as the execution condition for the associated CPC, which may cause connection failure to occur. On the other hand, since the UE may also evaluate cells as non-serving cells (e.g., PSCell in CHO configuration and/or PSCell of the associated CPC configuration) even after the non-serving cell becomes a serving cell, the associated CPC may not be executed in a timely manner.

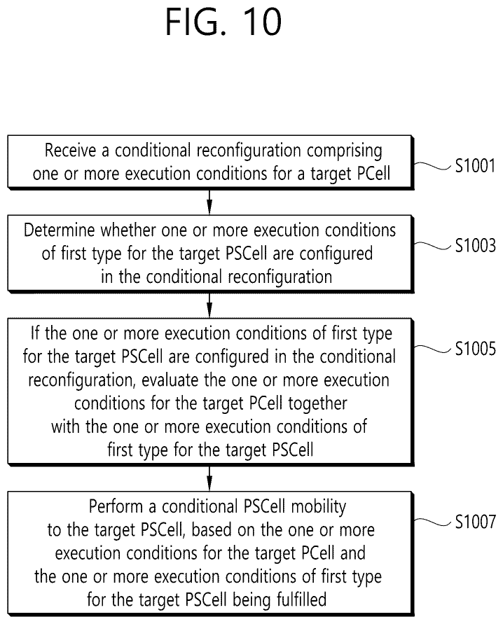

FIG. 10 shows an example of a method performed by a UE according to an embodiment of the present disclosure. The method may also be performed by a wireless device.

Referring to FIG. 10, in step S1001, the UE may receive a conditional reconfiguration comprising one or more execution conditions for a target PCell.

In step S1003, the UE may determine whether one or more execution conditions of first type for the target PSCell are configured in the conditional reconfiguration.

In step S1005, based on the one or more execution conditions of first type for the target PSCell being configured in the conditional reconfiguration, the UE may evaluate the one or more execution conditions for the target PCell together with the one or more execution conditions of first type for the target PSCell.

In step S1007, the UE may perform a conditional PSCell mobility to the target PSCell, based on the one or more execution conditions for the target PCell and the one or more execution conditions of first type for the target PSCell being fulfilled.

According to various embodiments, the UE may perform a CHO to the target PCell, based on the one or more execution conditions for the target PCell and the one or more execution conditions of first type for the target PSCell being fulfilled.

According to various embodiments, the UE may perform the CHO to the target PCell while performing the conditional PSCell mobility to the target PSCell.

According to various embodiments, both of the CHO to the target PCell and the conditional PSCell mobility to the target PSCell may not be performed, based on at least one of: i) the one or more execution conditions for the target PCell; or ii) the one or more execution conditions of first type for the target PSCell, being not fulfilled.

According to various embodiments, the one or more execution conditions of first type for the target PSCell may be evaluated before the CHO to the target PCell is initiated.

According to various embodiments, the conditional reconfiguration may further comprise a cell configuration for the target PCell and a cell configuration for the target PSCell. While performing the CHO to the target PCell, the UE may apply the cell configuration for the target PCell. While performing the conditional PSCell mobility to the target PSCell, the UE may apply the cell configuration for the target PSCell.

According to various embodiments, the UE may evaluate the one or more execution conditions of first type for the target PSCell while evaluating the one or more execution conditions for the target PCell.

According to various embodiments, the conditional reconfiguration is a first conditional reconfiguration for the target PCell. The first conditional reconfiguration for the target PCell may comprise a second conditional reconfiguration for the target PSCell comprising one or more execution conditions of second type for the target PSCell. The one or more execution conditions of second type for the target PSCell may be evaluated after a conditional handover (CHO) to the target PCell is successfully completed.

According to various embodiments, the one or more execution conditions of first type for the target PSCell may be included in the first conditional reconfiguration for the target PCell, and may not be included in the second conditional reconfiguration for the target PSCell comprising the one or more execution conditions of second type for the target PSCell.

According to various embodiments, the first conditional reconfiguration for the target PCell may be associated with multiple SCGs. The target PSCell may be included in an SCG among the multiple SCGs.

According to various embodiments, based on the one or more execution conditions of first type for the target PSCell being not configured in the conditional reconfiguration, the UE may evaluate the one or more execution conditions for the target PCell. The UE may perform a CHO to the target PCell, based on the one or more execution conditions for the target PCell being fulfilled. The UE may evaluate one or more execution conditions of second type for the target PSCell, after successfully completing the CHO to the target PCell. The UE may perform the conditional PSCell mobility to the target PSCell, based on the one or more execution conditions of second type for the target PSCell being fulfilled.

According to various embodiments, the conditional PSCell mobility may comprise at least one of a CPA or a CPC.

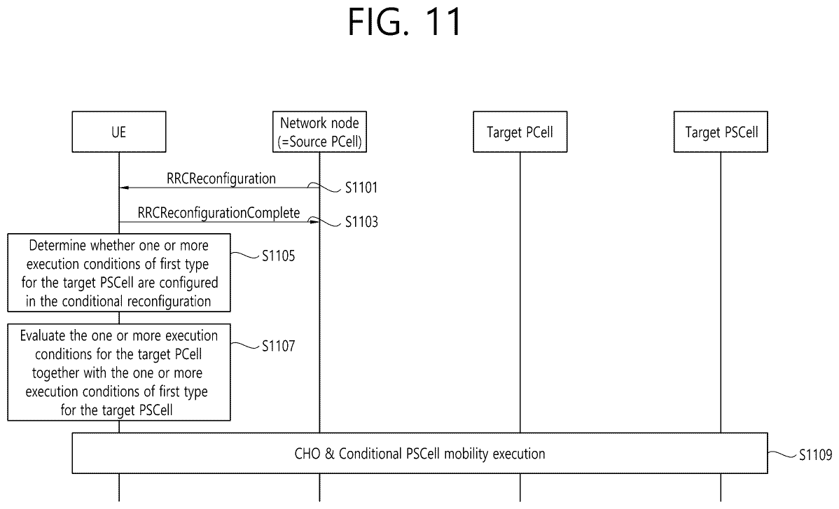

FIG. 11 shows an example of a signal flow between a UE and a network node according to an embodiment of the present disclosure. The network node may comprise a base station (BS), and may be related to a source PCell for CHO.

Referring to FIG. 11, in step 1101, the network node may transmit, to a UE, an RRC reconfiguration message comprising a conditional reconfiguration comprising one or more execution conditions for a target PCell.

In step S1103, the network node may receive, from the UE, an RRC reconfiguration complete message.

In step S1105, the UE may determine whether one or more execution conditions of first type for the target PSCell are configured in the conditional reconfiguration.

In step S1107, based on the one or more execution conditions of first type for the target PSCell being configured in the conditional reconfiguration, the UE may evaluate the one or more execution conditions for the target PCell together with the one or more execution conditions of first type for the target PSCell.

In step S1109, the UE may perform a CHO to the target PCell and a conditional PSCell mobility to the target PSCell, based on the one or more execution conditions for the target PCell and the one or more execution conditions of first type for the target PSCell being fulfilled.

According to implementations of the present disclosure, when a UE receives a configuration of conditional mobility (i.e., conditional reconfiguration) comprising execution condition(s) for both a master cell group (MCG) and a secondary cell group (SCG), UE may determine whether the UE can simultaneously evaluate the execution condition(s) for both the master cell group and the secondary cell group (i.e., perform simultaneous evaluation of the execution condition(s) for both the master cell group and the secondary cell group). For performing the simultaneous evaluation, the UE may check whether at least one execution condition for the secondary cell group that can be evaluated together with the other execution condition(s) for the master cell group (i.e., execution condition of first type for PSCell) is available.

The secondary cell group may comprise a cell group that could be configured with the master cell group after conditional mobility to the master cell group is successfully completed.

For the simultaneous evaluation of both the master cell group and the secondary cell group, the network may provide a new type of execution condition (i.e., execution condition of first type for PSCell) or a new type of indication to the UE.

If the network configures the new type of the execution condition for the simultaneous evaluation of both the master cell group and the secondary cell group, at least one of the below execution condition(s) (i.e., execution condition(s) of first type for PSCell) may be configured to the UE:
New execution condition 1: Neighbour cell 1 becomes offset better than Neighbour cell 2;
New execution condition 2: Candidate cell 1 becomes offset better than Candidate cell 2;
New execution condition 3: Potential target SpCell becomes offset better than target SpCell;
New execution condition 4: Potential SpCell in conditional mobility for the SCG becomes offset better than another potential SpCell in conditional mobility for the MCG;
New execution condition 5: Neighbour cell 1 becomes worse than threshold1 and Neighbour cell 2 becomes better than threshold2;
New execution condition 6: Candidate cell 1 becomes worse than threshold1 and Candidate cell 2 becomes better than threshold2;
New execution condition 7: Potential target SpCell becomes worse than threshold1 and target SpCell becomes better than threshold2; or
New execution condition 8: Potential SpCell in conditional mobility for the MCG becomes worse than threshold1 and potential SpCell in conditional mobility for the SCG becomes better than threshold2.

If the network configures the new indication to allow the simultaneous evaluation of both the master cell group and the secondary cell group, the network may set the indication per every execution condition so that the UE can simultaneously evaluate the execution condition without new execution conditions.

If the UE receives at least one execution condition for the simultaneous evaluation of both the master cell group and the secondary cell group, the UE may start evaluating the execution condition of the conditional mobility for the secondary cell group (i.e., execution condition of first type for PSCell) simultaneously with the execution condition of the conditional mobility for master cell group (i.e., execution condition for PCell). Namely, the UE may evaluate the execution condition of the conditional mobility for the secondary cell group before successfully completing the conditional mobility for the master cell group.

If at least one execution condition of the conditional mobility for the secondary cell group is met, the UE may check whether any execution condition of the conditional mobility for the master cell group has been met. Unless any execution condition of the conditional mobility for the master cell group has been met, the UE doesn't initiate to perform the conditional mobility for the secondary cell group regardless of the status of the execution condition of the conditional mobility for the secondary cell group (i.e., regardless of whether the execution condition of the conditional mobility for the secondary cell group is met).

If at least one execution condition of the conditional mobility for the master cell group is met, the UE may check whether any execution condition of the conditional mobility for the secondary cell group has been met. If there is at least one execution condition of the conditional mobility for the secondary cell group has been met before performing the conditional mobility for the master cell group, the UE may simultaneously initiate the conditional mobility for the secondary cell group together with the conditional mobility for the master cell group.

After conditional mobility for the master cell group is successfully completed, the UE may determine whether the UE evaluates the execution condition(s) for the secondary cell group.

If the UE completes the conditional mobility for the master cell group and the conditional mobility for the secondary cell group after the UE simultaneously initiates the conditional mobility for the secondary cell group together with the conditional mobility for the master cell group, the UE may stop evaluating the execution conditions for the conditional mobility for the master cell group and the secondary cell group.

If the UE completes the conditional mobility for the master cell group after the conditional mobility for the master cell group is initiated but the conditional mobility for the secondary cell group is not initiated, the UE may check whether at least one execution condition for the secondary cell group that is to be evaluated (i.e., at least one execution condition of second type for PSCell) is available after the conditional mobility to the master cell group is completed.

For the evaluation of the execution condition(s) for the secondary cell group after the UE completes the conditional mobility for the master cell group, the network may provide legacy execution conditions (i.e., execution conditions of second type for PSCell). The legacy execution conditions may be configured together with the new type of execution condition (i.e., execution condition of first type for PSCell) or the new type of indication before/when the UE completes the conditional mobility for the master cell group.

For the evaluation of the secondary cell group after the UE completes the conditional mobility for the master cell group if the network configures the legacy execution conditions, at least one of the below execution condition(s) (i.e., execution condition(s) of second type for PSCell) may be configured to the UE:
A1: Serving becomes better than threshold;
A2: Serving becomes worse than threshold;
A3: Neighbour becomes offset better than SpCell;
A4: Neighbour becomes better than threshold;
A5: SpCell becomes worse than threshold1 and neighbour becomes better than threshold2;
A6: Neighbour becomes offset better than SCell;
B1: Inter RAT neighbour becomes better than threshold; or
B2: PCell becomes worse than threshold1 and inter RAT neighbour becomes better than threshold2.

If the UE is configured with at least one of the legacy execution conditions for the conditional mobility for the secondary cell group, the UE may stop evaluating the new type of execution condition and start evaluating the legacy execution condition(s) for the secondary cell group. The UE may maintain the evaluation status (e.g., time-to-trigger value) related to the new type of execution condition (i.e., execution condition of first type for PSCell), even if the UE stop evaluating the new type of execution condition when the UE starts evaluating the legacy execution condition(s) for the conditional mobility to the secondary cell group.

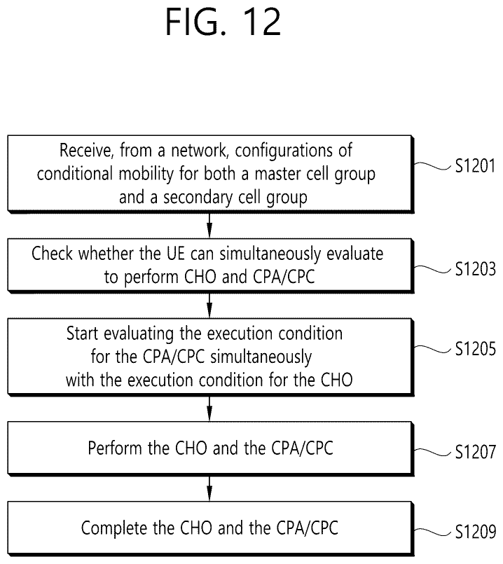

FIG. 12 shows an example of a method for simultaneous evaluation of conditional PCell/PSCell mobility conditions according to an embodiment of the present disclosure. The method may be performed by a UE and/or a wireless device.

Referring to FIG. 12, in step S1201, the UE may receive, from a network, configurations of conditional mobility (i.e., conditional reconfigurations) for both a master cell group and a secondary cell group. The network may configure the UE with conditional mobility for both the master cell group and the secondary cell group.

The UE may receive RRC reconfiguration message(s) comprising configurations of conditional mobility for both the master cell group for CHO and the secondary cell group for CPA/CPC. In the RRC reconfiguration message, one or more conditional reconfigurations for the CHO and the CPA/CPC may be included. Each conditional reconfiguration may include: cell configurations for mobility to a potential PCell (for CHO) or PSCell (for CPA/CPC); and/or one or more execution conditions for the potential PCell (for CHO) or PSCell (for CPA/CPC). Especially for the CPA/CPC, the conditional reconfiguration for CPA/CPC may be included in the conditional reconfiguration for the CHO, and the conditional reconfiguration for CPA/CPC included in the conditional reconfiguration for the CHO may not be initiated before initiation of the CHO (i.e., CPA/CPC cannot be initiated until CHO is initiated).

In step S1203, the UE may check whether the UE can simultaneously evaluate to perform CHO and CPA/CPC.

In the received RRC reconfiguration for CHO and CPA/CPC, one or more execution conditions for CHO and/or CPA/CPC may also be included. The UE may check whether there is at least one execution condition for CPA/CPC that is allowed to be evaluated before initiation of the CHO (i.e., at least one execution condition of first type for PSCell). The UE may check whether at least one of the below execution conditions for the CPA/CPC (i.e., execution conditions of first type for PSCell) are included in the RRC reconfiguration:
New execution condition 1: Neighbour cell 1 becomes offset better than Neighbour cell 2;
New execution condition 2: Candidate cell 1 becomes offset better than Candidate cell 2;
New execution condition 3: Potential target SpCell becomes offset better than target SpCell;
New execution condition 4: Neighbour cell 1 becomes worse than threshold1 and Neighbour cell 2 becomes better than threshold2;
New execution condition 5: Candidate cell 1 becomes worse than threshold1 and Candidate cell 2 becomes better than threshold2; or
New execution condition 6: Potential target SpCell becomes worse than threshold1 and target SpCell becomes better than threshold2.

If there is no execution condition for CPA/CPC that is allowed to be evaluated before initiation of the CHO, the UE may just evaluate the execution condition for the CHO until the CHO is initiated.

In step S1205, the UE may start evaluating the execution condition for the CPA/CPC (i.e., execution condition of first type for PSCell) simultaneously with the execution condition for the CHO.

Based on the new execution conditions (i.e., execution condition of first type for PSCell), the UE may evaluate the new execution conditions for CPA/CPC while evaluating the execution condition for the CHO. If at least one new execution condition for the CPA/CPC is met, the UE may check whether any execution condition for the CHO has been met. Unless any execution condition for the CHO has been met, the UE doesn't initiate to perform the CPA/CPC regardless of the status of the new execution condition (i.e., regardless of whether the new execution condition for the CPA/CPC is met).

In step S1207, the UE may perform the CHO and the CPA/CPC.

Upon determining to initiate the CHO based on at least one execution condition for the CHO being met, the UE may check whether any new execution condition for CPA/CPC has been met. If at least one new execution condition for CPA/CPC has been met before the execution condition for the CHO is met, the UE may perform the CHO and the CPA/CPC together. To perform the CHO and the CPA/CPC together, the UE may apply the conditional reconfiguration for the CHO and simultaneously apply the conditional reconfiguration for the CPA/CPC. Otherwise, if there is no new execution condition that has been met before the execution condition for the CHO is met, the UE may just perform the CHO.

In step S1209, the UE may complete the CHO and the CPA/CPC.

The UE may perform synchronisation with the selected PCell (i.e., target of CHO for which execution condition is met) and PSCell (i.e., target of CPA/CPC for which execution condition is met), according to the corresponding conditional reconfiguration for the CHO and/or the CPA/CPC. After successful synchronization, the UE may send RRC reconfiguration complete messages to the selected PCell and PSCell individually to indicate the CHO and the CPA/CPC completion.

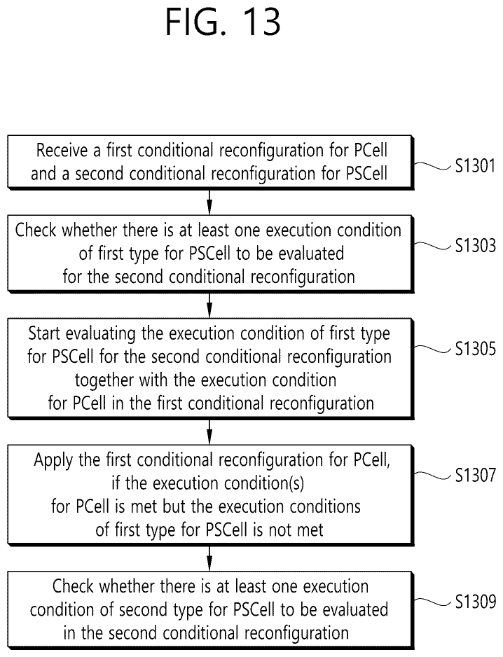

FIG. 13 shows an example of a first implementation of a method for simultaneous evaluation of conditional PCell/PSCell mobility conditions according to an embodiment of the present disclosure. The method may be performed by a UE and/or a wireless device.

Referring to FIG. 13, in step S1301, the UE may receive a first conditional reconfiguration for PCell and a second conditional reconfiguration for PSCell. The first conditional reconfiguration may include one or more execution conditions for PCell, and one or more cell configurations for PCell. The second conditional reconfiguration may include one or more execution conditions of second type for PSCell, and one or more cell configurations for PSCell. The second conditional reconfiguration for PSCell should not be used before applying the first conditional reconfiguration for PCell—that is, the one or more execution conditions of second type for PSCell should not be evaluated before applying the first conditional reconfiguration for PCell.

In step S1303, the UE may check whether there is at least one execution condition of first type for PSCell to be evaluated for the second conditional reconfiguration. The at least one execution condition of first type for PSCell may comprise a condition that a neighbour cell becomes better than another neighbour cell.

In step S1305, the UE may start evaluating the execution condition of first type for PSCell for the second conditional reconfiguration together with the execution condition for PCell in the first conditional reconfiguration, when there is at least one execution condition of first type for PSCell to be evaluated for the second conditional reconfiguration.

In step S1307, the UE may apply the first conditional reconfiguration for PCell only, if the execution condition(s) for PCell is met but the execution conditions of first type for PSCell is not met.

In step S1309, the UE may check whether there is at least one execution condition of second type for PSCell to be evaluated in the second conditional reconfiguration. The execution condition of second type for PSCell may comprise a condition that a neighbour cell becomes better than serving cell.

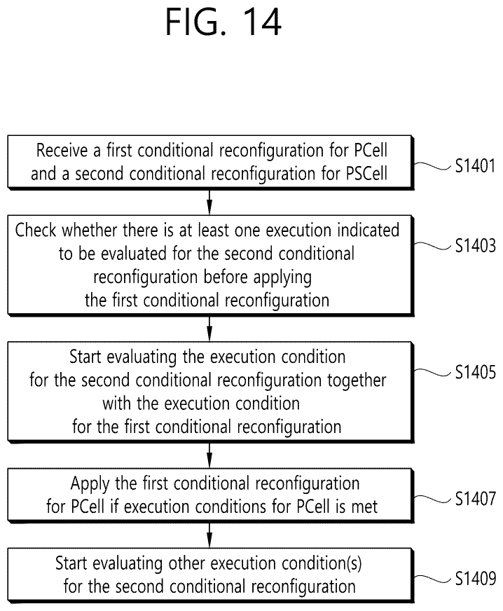

FIG. 14 shows an example of a second implementation of a method for simultaneous evaluation of conditional PCell/PSCell mobility conditions according to an embodiment of the present disclosure. The method may be performed by a UE and/or a wireless device.

Referring to FIG. 14, in step S1401, the UE may receive a first conditional reconfiguration for PCell and a second conditional reconfiguration for PSCell. Each conditional reconfiguration may include one or more execution conditions and one or more cell configurations. The second conditional reconfiguration for PSCell should not be used before applying the first conditional reconfiguration for PCell.

In step S1403, the UE may check whether there is at least one execution indicated to be evaluated for the second conditional reconfiguration before applying the first conditional reconfiguration. It may be indicated by the network whether or not to evaluate the at least one condition before applying the first conditional reconfiguration.

In step S1405, the UE may start evaluating the execution condition for the second conditional reconfiguration (i.e., execution condition for PSCell) together with the execution condition for the first conditional reconfiguration (i.e., execution condition for PCell) only if the execution condition is indicated by the network to be evaluated before applying the first conditional reconfiguration.

In step S1407, the UE may apply the first conditional reconfiguration for PCell if execution conditions for PCell is met.

In step S1409, the UE may start evaluating other execution condition(s) for the second conditional reconfiguration only if the other execution condition(s) is/are indicated by the network to be evaluated when/after applying the first conditional reconfiguration.

In step S1411, the UE may apply the second conditional reconfiguration for PSCell when the other execution condition(s) is/are met.

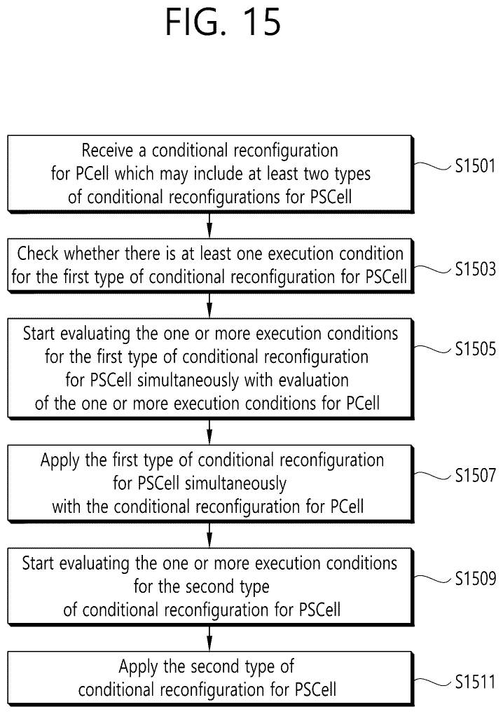

FIG. 15 shows an example of a third implementation of a method for simultaneous evaluation of conditional PCell/PSCell mobility conditions according to an embodiment of the present disclosure. The method may be performed by a UE and/or a wireless device.

Referring to FIG. 15, in step S1501, the UE may receive a conditional reconfiguration for PCell which may include at least two types of conditional reconfigurations for PSCell. Each conditional reconfiguration may comprise one or more execution conditions and corresponding cell configuration(s).

The one or more execution conditions for a first type of conditional reconfiguration for PSCell (i.e., execution condition(s) of first type for PSCell) may be evaluated together with evaluation of the execution condition(s) for PCell.

The one or more execution conditions for a second type of conditional reconfiguration for PSCell (i.e., execution condition(s) of second type for PSCell) are not available to be evaluated together with the evaluation of the execution condition(s) for PCell.

In step S1503, the UE may check whether there is at least one execution condition for the first type of conditional reconfiguration for PSCell (i.e., at least one execution condition of first type for PSCell).

In step S1505, the UE may start evaluating the one or more execution conditions for the first type of conditional reconfiguration for PSCell simultaneously with evaluation of the one or more execution conditions for PCell.

In step S1507, the UE may apply the first type of conditional reconfiguration for PSCell simultaneously with the conditional reconfiguration for PCell, when at least one execution condition for the first type of conditional reconfiguration for PSCell and at least one execution condition for the conditional reconfiguration for PCell are met.

In step S1509, the UE may start evaluating the one or more execution conditions for the second type of conditional reconfiguration for PSCell (i.e., one or more execution conditions of second type for PSCell), when the UE completes applying the first type of conditional reconfiguration for PSCell simultaneously with the conditional reconfiguration for PCell.

In step S1511, the UE may apply the second type of conditional reconfiguration for PSCell, when at least one execution condition for the second type of conditional reconfiguration for PSCell is met.

According to various embodiments, the UE may receive a list of conditional reconfigurations (i.e., CondReconfigToAddModList IE) from a network. The IE CondReconfigToAddModList concerns a list of conditional reconfigurations to add or modify, with for each entry the condReconfigId and the associated fields, as shown in table 5 below:

TABLE 5

| | |
|---|---|
| CondReconfigToAddModList-r16 ::= | SEQUENCE (SIZE (1.. maxNrofCondCells- |

r16)) OF CondReconfigToAddMod-r16

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF MeasId |

OPTIONAL, -- Need M

| | |
|---|---|
| condRRCReconfig-r16 | OCTET STRING (CONTAINING |
| RRCReconfiguration) | OPTIONAL, -- Cond condReconfigAdd |

```
    ...,
    [[
```

| | |
|---|---|
| condExecutionCondSCG-r17 | OCTET STRING (CONTAINING |
| CondReconfigExecCondSCG-r17) | OPTIONAL -- Need M |

```
    ]],
    [[
```

| | |
|---|---|
| condExecutionCondPSCell-r18 | SEQUENCE (SIZE (1..2)) OF MeasId |

OPTIONAL, -- Cond condReconfigCHO-WithSCG

| | |
|---|---|
| subsequentCondReconfig-r18 | SubsequentCondReconfig-r18 |

OPTIONAL, -- Need M

| | |
|---|---|
| securityCellSetId-r18 | SecurityCellSetId-r18 |

OPTIONAL, -- Need M

| | |
|---|---|
| scpac-ConfigComplete-r18 | ENUMERATED {true} |

```
OPTIONAL -- Cond CPAC
    ]]
  }
```

| | |
|---|---|
| CondReconfigExecCondSCG-r17 ::= | SEQUENCE (SIZE (1..2)) OF MeasId |
| SubsequentCondReconfig-r18 ::= | SEQUENCE { |

condExecutionCondToReleaseList-r18

| | |
|---|---|
| CondExecutionCondToReleaseList-r18 | OPTIONAL, -- Need N |

condExecutionCondToAddModList-r18

| | |
|---|---|
| CondExecutionCondToAddModList-r18 | OPTIONAL, -- Need N |

```
    ...
  }
```

| | |
|---|---|
| CondExecutionCondToAddModList-r18 ::= | SEQUENCE (SIZE (1.. |

maxNrofCondCells-r16)) OF CondExecutionCondToAddMod-r18

| | |
|---|---|
| CondExecutionCondToAddMod-r18 ::= | SEQUENCE { |
| condReconfigId-r18 | CondReconfigId-r16, |
| condExecutionCond-r18 | SEQUENCE (SIZE (1..2)) OF MeasId |

OPTIONAL, -- Need M

| | |
|---|---|
| condExecutionCondSCG-r18 | OCTET STRING (CONTAINING |
| CondReconfigExecCondSCG-r17) | OPTIONAL, -- Need M |

```
    ...
  }
```

| | |
|---|---|
| CondExecutionCondToReleaseList-r18 :: | SEQUENCE (SIZE (1.. |

maxNrofCondCells-r16)) OF CondReconfigId-r16

In table 5:—condExecutionCond (e.g., execution condition of second type for target PSCell) is the execution condition that needs to be fulfilled in order to trigger the execution of a conditional reconfiguration for CHO, CPA, intra-SN CPC without MN involvement, MN initiated inter-SN CPC, or SN initiated intra-SN subsequent CPAC without MN involvement. When configuring 2 triggering events (Meas Ids) for a candidate cell, the network ensures that both refer to the same measObject. For CHO, if the network configures condEventD1 or condEventT1 for a candidate cell, the network configures a second triggering event condEventA3, condEventA4 or condEventA5 for the same candidate cell. The network does not configure both condEventD1 and condEventT1 for the same candidate cell. For CHO in terrestrial networks, the network does not indicate a MeasId associated with condEventA4. For CPA and for MN-initiated inter-SN CPC, the network only indicates MeasId(s) associated with condEventA4. For intra-SN CPC and intra-SN subsequent CPAC, the network only indicates MeasId(s) associated with condEventA3 or condEventA5;
condExecutionCondPSCell (i.e., execution condition of first type for target PSCell) is the execution condition that needs to be fulfilled for the associated PSCell in order to trigger the execution of a conditional reconfiguration for CHO with candidate SCG(s). The Meas Ids refer to the measConfig associated with the MCG. When configuring 2 triggering events (Meas Ids) for a candidate cell, network ensures that both refer to the same measObject. The network only indicates MeasId(s) associated with condEventA4;
condExecutionCondSCG contains execution condition that needs to be fulfilled in order to trigger the execution of a conditional reconfiguration for SN initiated inter-SN CPC, SN initiated inter-SN subsequent CPAC, SN initiated intra-SN subsequent CPAC with MN involvement, or MN initiated inter-SN subsequent CPAC. The Meas Ids refer to the measConfig associated with the SCG. When configuring 2 triggering events (Meas Ids) for a candidate cell, network ensures that both refer to the same measObject. For each condReconfigId, the network always configures either condExecutionCond or condExecutionCondSCG (not both). The network only indicates MeasId(s) associated with condEventA3 or condEventA5;
condRRCReconfig is the RRCReconfiguration message comprising a cell configuration for the corresponding target cell to be applied when the condition(s) are fulfilled. The RRCReconfiguration message contained in condRRCReconfig cannot contain the field conditionalReconfiguration or the field daps-Config;
scpac-ConfigComplete indicates whether the configuration contained in condRRCReconfig for subsequent CPAC is a complete configuration; and
subsequentCondReconfig contains the execution conditions (e.g., execution condition of second type for target PSCell) that need to be fulfilled in order to trigger the execution of a subsequent CPAC. If the field is configured, the configuration of candidate PSCells for subsequent CPAC is supported. The subsequent execution condition is used for conditional reconfiguration evaluation for other candidate cells when the RRCReconfiguration message contained in condRRCReconfig has been applied.

After receiving the list of conditional reconfigurations, the UE may perform conditional reconfiguration evaluation. The UE shall:
1> for each condReconfigId within the VarConditionalReconfig:
2> if the RRCReconfiguration within condRRCReconfig includes the masterCellGroup including the reconfiguration WithSync:
3> if the associated condExecutionCondPSCell is configured:
4> consider the cell which has a physical cell identity matching the value indicated in the ServingCellConfigCommon included in the reconfigurationWithSync within the masterCellGroup in the received condRRCReconfig to be applicable cell; and
4> consider the cell which has a physical cell identity matching the value indicated in the ServingCellConfigCommon included in the reconfigurationWithSync within the secondaryCellGroup within the nr-SCG within the received condRRCReconfig to be applicable cell;
3> else:
4> consider the cell which has a physical cell identity matching the value indicated in the ServingCellConfigCommon included in the reconfigurationWithSync within the masterCellGroup in the received condRRCReconfig to be applicable cell;
2> else if the RRCReconfiguration within condRRCReconfig includes the secondaryCellGroup including the reconfiguration WithSync:
3> if the cell which has a physical cell identity matching the value indicated in the ServingCellConfigCommon included in the reconfigurationWithSync within the secondaryCellGroup within the received condRRCReconfig is not the PSCell:
4> consider the cell to be applicable cell;
2> if condExecutionCondSCG is configured:
3> in the remainder of the procedure, consider each measId indicated in the condExecutionCondSCG as a measId in the VarMeasConfig associated with the SCG measConfig;
2> if the condExecutionCondPSCell is configured:
3> in the remainder of the procedure, consider each measId indicated in the condExecutionCondPSCell as a measId in the VarMeasConfig associated with the MCG measConfig;
2> if condExecutionCond is configured:
3> if it is configured via SRB3 or configured within nr-SCG or within nr-SecondaryCellGroupConfig via SRB1:
4> in the remainder of the procedure, consider each measId indicated in the condExecutionCond as a measId in the VarMeasConfig associated with the SCG measConfig;
3> else:
4> in the remainder of the procedure, consider each measId indicated in the condExecutionCond as a measId in the VarMeasConfig associated with the MCG measConfig;
2> for each measId included in the measIdList within VarMeasConfig indicated in the condExecutionCond, condExecutionCondSCG, or condExecutionCondPSCell associated to condReconfigId:
3> if the condEventId is associated with condEventT1, and if the entry condition applicable for this event associated with the condReconfigId, i.e. the event corresponding with the condEventId(s) of the corresponding condTriggerConfig within VarConditionalReconfig, is fulfilled for the applicable cell; or
3> if the condEventId is associated with condEventD1, and if the entry conditions applicable for this event associated with the condReconfigId, i.e. the event corresponding with the condEventId(s) of the corresponding condTriggerConfig within VarConditionalReconfig, is fulfilled for the applicable cell during the corresponding timeToTrigger defined for this event within the VarConditionalReconfig; or
3> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be fulfilled;
3> if the measId for this event associated with the condReconfigId has been modified; or
3> if the condEventId is associated with condEventT1, and if the leaving condition applicable for this event associated with the condReconfigId, i.e. the event corresponding with the condEventId(s) of the corresponding condTriggerConfig within VarConditionalReconfig, is fulfilled for the applicable cell; or
3> if the condEventId is associated with condEventD1, and if the leaving condition(s) applicable for this event associated with the condReconfigId, i.e. the event corresponding with the condEventId(s) of the corresponding condTriggerConfig within VarConditionalReconfig, is fulfilled for the applicable cell during the corresponding timeToTrigger defined for this event within the VarConditionalReconfig; or
3> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be not fulfilled;
2> if condExecutionCondPSCell is not configured:
3> if event(s) associated to all measId(s) within condTriggerConfig for the applicable cell are fulfilled:
4> consider the applicable cell, associated to that condReconfigId, as a triggered cell;
4> initiate the conditional reconfiguration execution;
2> else:
3> if event(s) associated to all measId(s), as indicated in the condExecutionCond and condExecutionCondPSCell, within condTriggerConfig for a target candidate cell within the stored condRRCReconfig are fulfilled:
4> consider the target candidate PCell within the stored condRRCReconfig, associated to that condReconfigId, as a triggered PCell;
4> consider the target candidate PSCell within the stored condRRCReconfig, associated to that condReconfigId, as a triggered PSCell;
4> initiate the conditional reconfiguration execution.

Up to 2 MeasId can be configured for each condReconfigId, if condExecutionCondPSCell is not configured. The conditional reconfiguration event of the 2 MeasId may have the same or different event conditions, triggering quantity, time to trigger, and triggering threshold.

For CHO with candidate SCGs, up to 2 MeasId can be configured for condExecutionCond and up to 2 MeasId can be configured for condExecutionCondPSCell for each condReconfigId.

Upon the conditional reconfiguration execution, the UE shall:
1> if more than one pair of triggered PCell and associated triggered PSCell exist:
2> select one of the triggered PCell(s) and the associated triggered PSCell(s) as the selected cells for conditional reconfiguration execution;
1> else if only one pair of triggered PCell and associated triggered PSCell exists:
2> consider the triggered PCell and the associated triggered PSCell as the selected cells for conditional reconfiguration execution;
1> else if more than one triggered cell exists:
2> select one of the triggered cells as the selected cell for conditional reconfiguration execution;
1> else:
2> consider the triggered cell as the selected cell for conditional reconfiguration execution;
1> for the selected cell(s) of conditional reconfiguration execution:
2> if the subsequentCondReconfig is included in the entry in VarConditionalReconfig containing the RRCReconfiguration message for the selected cell:
3> perform the subsequent CPAC execution;
2> else:
3> apply the stored condRRCReconfig of the selected cell and apply RRCReconfiguration in the condRRCReconfig.

If multiple NR cells are triggered in conditional reconfiguration execution, the UE may select one of them. For example, the UE may consider beams and/or beam quality to select one of the triggered cells for execution.

Upon the conditional reconfiguration execution for subsequent CPAC, the UE shall:
1> if the selected subsequent CPAC candidate configuration is stored in MCG VarConditionalReconfig:
2> release/clear all current dedicated radio configuration except for the following:
   the MCG C-RNTI;
   the AS security configurations associated with the master key and the secondary key;
   for each SRB/DRB in current UE configuration:
   keep the associated RLC, PDCP and SDAP entities, their state variables, buffers and timers;
   release all fields related to the SRB/DRB configuration except for srb-Identity and drb-Identity;
   the UE variables VarConditionalReconfig and VarServingSecurityCellSetID.
2> release/clear all current common radio configuration;
1> else:
2> release/clear all current dedicated radio configuration associated with the SCG except for the following:
   the AS security configurations associated with the secondary key;
   for each SRB/DRB in current UE configuration which is using the secondary key:
   keep the associated RLC, PDCP and SDAP entities, their state variables, buffers and timers;
   release all fields related to the SRB/DRB configuration except for srb-Identity and drb-Identity;
   the UE variables VarConditionalReconfig.
2> release/clear all current common radio configuration associated with the SCG;
1> use the default values for timers T310, T311 and constants N310, N311 for the cell group for which the subsequent CPAC cell switch procedure is triggered;
1> if the securityCellSetId is included in the entry in VarConditionalReconfig containing the RRCReconfiguration message:
2> if servingSecurityCellSetId is not included within VarServingSecurityCellSetID; or
2> if the value of the securityCellSetId is not equal to the value of servingSecurityCellSetId within VarServingSecurityCellSetID:
3> consider the first sk-Counter value in the sk-CounterList associated with the securityCellSetId within the VarConditionalReconfig as the selected sk-Counter value, and perform security key update procedure;
3> remove the selected sk-Counter value from the sk-CounterList associated with the securityCellSetId within the VarConditionalReconfig;
3> if the current VarServingSecurityCellSetID includes servingSecurityCellSetId:
4> replace the value of servingSecurityCellSetId within VarServingSecurityCellSetID with the value of securityCellSetId associated with the selected cell;
3> else:
4> store the servingSecurityCellSetId within VarServingSecurityCellSetID with the value of securityCellSetId associated with the selected cell;
1> if the selected subsequent CPAC candidate configuration is stored in the SCG VarConditionalReconfig:
2> for each drb-Identity value included in RadioBearerConfig associated with the secondary key (S-K_{gNB}) as indicated by keyToUse that is part of the current UE configuration:
3> trigger the PDCP entity of the AM DRB to perform PDCP data recovery;
3> re-establish the corresponding RLC entity;
1> else:
2> for each drb-Identity value included in RadioBearerConfig that is part of the current UE configuration:
3> if a different keyToUse value is configured; or
3> if a new sk-Counter value has been selected due to the conditional reconfiguration execution for subsequent CPAC:
4> trigger the PDCP entity of the bearer to perform PDCP reestablishment;
3> else:
4> trigger the PDCP entity of the AM DRB to perform PDCP data recovery;
4> re-establish the corresponding RLC entity;
1> if scpac-ConfigComplete is not included within the VarConditionalReconfig for the selected cell:
2> if the subsequent CPAC candidate cell configuration is stored in MCG VarConditionalReconfig:
3> consider scpac-ReferenceConfiguration in MCG VarConditionalReconfig to be the current UE configuration;
2> else:
3> consider scpac-ReferenceConfiguration in SCG VarConditionalReconfig to be the current SCG configuration;

When the UE considers the reference configuration to be the current UE configuration, the UE should store fields and configurations that are part of the reference configuration but should not execute any actions or procedures triggered by the reception of an RRCReconfiguration message.
1> apply the stored condRRCReconfig of the selected cell(s) and apply the RRCReconfiguration in the condRRCReconfig.
1> release the radio bearer(s) and the associated logical channel(s) that are part of the current UE configuration but not part of the subsequent CPAC candidate configuration for the selected cell, or the subsequent CPAC reference configuration (in case the subsequent CPAC candidate configuration does not include scpac-ConfigComplete).

When scpac-ConfigComplete is not included for the selected cell, before a subsequent CPAC execution, a UE implementation may generate and store an RRC reconfiguration message by applying the received subsequent CPAC candidate configuration on top of the subsequent CPAC reference configuration, and the stored RRC reconfiguration message is applied for subsequent CPAC execution.

Furthermore, the method in perspective of the UE described in the present disclosure (e.g., in FIG. 10) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: receiving a conditional reconfiguration comprising one or more execution conditions for a target primary cell (PCell); determining whether one or more execution conditions of first type for the target primary secondary cell (PSCell) are configured in the conditional reconfiguration; based on the one or more execution conditions of first type for the target PSCell being configured in the conditional reconfiguration, evaluating the one or more execution conditions for the target PCell together with the one or more execution conditions of first type for the target PSCell; and performing a conditional PSCell mobility to the target PSCell, based on the one or more execution conditions for the target PCell and the one or more execution conditions of first type for the target PSCell being fulfilled.

Furthermore, the method in perspective of the UE described in the present disclosure (e.g., in FIG. 10) may be performed by a software code 105 stored in the memory 104 included in the first wireless device 100 shown in FIG. 2.

More specifically, at least one computer readable medium (CRM) stores instructions that, based on being executed by at least one processor, perform operations comprising: receiving a conditional reconfiguration comprising one or more execution conditions for a target primary cell (PCell); determining whether one or more execution conditions of first type for the target primary secondary cell (PSCell) are configured in the conditional reconfiguration; based on the one or more execution conditions of first type for the target PSCell being configured in the conditional reconfiguration, evaluating the one or more execution conditions for the target PCell together with the one or more execution conditions of first type for the target PSCell; and performing a conditional PSCell mobility to the target PSCell, based on the one or more execution conditions for the target PCell and the one or more execution conditions of first type for the target PSCell being fulfilled.

Furthermore, the method in perspective of the UE described in the present disclosure (e.g., in FIG. 10) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: receiving a conditional reconfiguration comprising one or more execution conditions for a target primary cell (PCell); determining whether one or more execution conditions of first type for the target primary secondary cell (PSCell) are configured in the conditional reconfiguration; based on the one or more execution conditions of first type for the target PSCell being configured in the conditional reconfiguration, evaluating the one or more execution conditions for the target PCell together with the one or more execution conditions of first type for the target PSCell; and performing a conditional PSCell mobility to the target PSCell, based on the one or more execution conditions for the target PCell and the one or more execution conditions of first type for the target PSCell being fulfilled.

Furthermore, the method in perspective of a network node related to a source PCell for CHO described in the present disclosure (e.g., in FIG. 11) may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise: transmitting, to a user equipment (UE), a radio resource control (RRC) reconfiguration message comprising a conditional reconfiguration comprising one or more execution conditions for a target PCell; and receiving, from the UE, an RRC reconfiguration complete message, wherein the UE is configured to: determine whether one or more execution conditions of first type for the target primary secondary cell (PSCell) are configured in the conditional reconfiguration; based on the one or more execution conditions of first type for the target PSCell being configured in the conditional reconfiguration, evaluate the one or more execution conditions for the target PCell together with the one or more execution conditions of first type for the target PSCell; and perform a conditional PSCell mobility to the target PSCell, based on the one or more execution conditions for the target PCell and the one or more execution conditions of first type for the target PSCell being fulfilled.

The present disclosure may have various advantageous effects.

For example, the UE can check whether simultaneous evaluation of execution conditions for CHO and the associated CPC is available based on the configured execution condition. The UE can select suitable PSCell from the associated CPC configuration while performing the simultaneous evaluation.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a user equipment (UE) configured to operate in a wireless communication system, the method comprising:
receiving a conditional reconfiguration comprising one or more execution conditions for a target primary cell (PCell);
determining whether one or more execution conditions of first type for the target primary secondary cell (PSCell) are configured in the conditional reconfiguration;
based on the one or more execution conditions of first type for the target PSCell being configured in the conditional reconfiguration, evaluating the one or more execution conditions for the target PCell together with the one or more execution conditions of first type for the target PSCell; and
performing a conditional PSCell mobility to the target PSCell, based on the one or more execution conditions for the target PCell and the one or more execution conditions of first type for the target PSCell being fulfilled.

2. The method of claim 1, further comprising:
performing a conditional handover (CHO) to the target PCell, based on the one or more execution conditions for the target PCell and the one or more execution conditions of first type for the target PSCell being fulfilled.

3. The method of claim 2, wherein the performing of the CHO to the target PCell comprises performing the CHO to the target PCell while performing the conditional PSCell mobility to the target PSCell.

4. The method of claim 2, wherein both of the CHO to the target PCell and the conditional PSCell mobility to the target PSCell are not performed, based on at least one of: i) the one or more execution conditions for the target PCell; or ii) the one or more execution conditions of first type for the target PSCell, being not fulfilled.

5. The method of claim 2, wherein the one or more execution conditions of first type for the target PSCell are evaluated before the CHO to the target PCell is initiated.

6. The method of claim 2, wherein the conditional reconfiguration further comprises a cell configuration for the target PCell and a cell configuration for the target PSCell,
wherein the performing of the CHO to the target PCell comprises applying the cell configuration for the target PCell, and
wherein the performing of the conditional PSCell mobility to the target PSCell comprises applying the cell configuration for the target PSCell.

7. The method of claim 1, wherein the evaluating of the one or more execution conditions for the target PCell together with the one or more execution conditions of first type for the target PSCell comprises:
evaluating the one or more execution conditions of first type for the target PSCell while evaluating the one or more execution conditions for the target PCell.

8. The method of claim 1, wherein the conditional reconfiguration is a first conditional reconfiguration for the target PCell,
wherein the first conditional reconfiguration for the target PCell comprises a second conditional reconfiguration for the target PSCell comprising one or more execution conditions of second type for the target PSCell, and
wherein the one or more execution conditions of second type for the target PSCell are evaluated after a conditional handover (CHO) to the target PCell is successfully completed.

9. The method of claim 8, wherein the one or more execution conditions of first type for the target PSCell are included in the first conditional reconfiguration for the target PCell, and not included in the second conditional reconfiguration for the target PSCell comprising the one or more execution conditions of second type for the target PSCell.

10. The method of claim 8, wherein the first conditional reconfiguration for the target PCell is associated with multiple secondary cell groups (SCGs), and
wherein the target PSCell is included in an SCG among the multiple SCGs.

11. The method of claim 1, based on the one or more execution conditions of first type for the target PSCell being not configured in the conditional reconfiguration, evaluating the one or more execution conditions for the target PCell;
performing a conditional handover (CHO) to the target PCell, based on the one or more execution conditions for the target PCell being fulfilled;
evaluating one or more execution conditions of second type for the target PSCell, after successfully completing the CHO to the target PCell; and
performing the conditional PSCell mobility to the target PSCell, based on the one or more execution conditions of second type for the target PSCell being fulfilled.

12. The method of claim 1, wherein the conditional PSCell mobility comprises at least one of a conditional PSCell addition (CPA) or a conditional PSCell change (CPC).

13. The method of claim 1, wherein the UE is in communication with at least one of a mobile device, a network, or autonomous vehicles.

14. A user equipment (UE) configured to operate in a wireless communication system, the UE comprising:
at least one transceiver;
at least one processor; and
at least one memory operatively coupled to the at least one processor and storing instructions that, based on being executed by the at least one processor, perform operations comprising:
receiving a conditional reconfiguration comprising one or more execution conditions for a target primary cell (PCell);
determining whether one or more execution conditions of first type for the target primary secondary cell (PSCell) are configured in the conditional reconfiguration;
based on the one or more execution conditions of first type for the target PSCell being configured in the conditional reconfiguration, evaluating the one or more execution conditions for the target PCell together with the one or more execution conditions of first type for the target PSCell; and
performing a conditional PSCell mobility to the target PSCell, based on the one or more execution conditions for the target PCell and the one or more execution conditions of first type for the target PSCell being fulfilled.

15. (canceled)

16. A network node related to a source primary cell (PCell) for conditional handover (CHO) configured to operate in a wireless communication system, the network node comprising:
at least one transceiver;
at least one processor; and
at least one memory operatively coupled to the at least one processor and storing instructions that, based on being executed by the at least one processor, perform operations comprising:
transmitting, to a user equipment (UE), a radio resource control (RRC) reconfiguration message comprising a conditional reconfiguration comprising one or more execution conditions for a target PCell; and
receiving, from the UE, an RRC reconfiguration complete message,
wherein the UE is configured to:
determine whether one or more execution conditions of first type for the target primary secondary cell (PSCell) are configured in the conditional reconfiguration;
based on the one or more execution conditions of first type for the target PSCell being configured in the conditional reconfiguration, evaluate the one or more execution conditions for the target PCell together with the one or more execution conditions of first type for the target PSCell; and
perform a conditional PSCell mobility to the target PSCell, based on the one or more execution conditions for the target PCell and the one or more execution conditions of first type for the target PSCell being fulfilled.

17-20. (canceled)
